(19) United States
(12) Patent Application Publication
(10) Pub. No.: US 2005/0242869 A1
(43) Pub. Date: Nov. 3, 2005

(54) Medium for storing and reading information, and device for storing and reading of information on and from the medium

(75) Inventor: Josephus Arnoldus Kahlman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., GROENEWOUDSEWEG 1 (NL)

(21) Appl. No.: 10/520,190

(22) PCT Filed: Jun. 27, 2003
(86) PCT No.: PCT/IB03/02937

§ 371 Date: Jan. 4, 2005

(30) Foreign Application Priority Data
Jul. 8, 2002 (EP) 02077713.2

(51) Int. Cl. G05F 1/10

(52) U.S. Cl. 327/536

(57) ABSTRACT

An integrated circuit (IC) is attached to a disc for writing/reading information. The disc may be used, for example, in an apparatus such as a CD-player. The IC comprises: a light sensor (SNS), a further light sensor (SNS_{F}), detection means (DT) (which are optional), microprocessor (uP), non-volatile memory means (MM) such as an EEPROM, an RF-oscillator (RF_{osc}), voltage conversion means (CNV), and a standby circuit (SB). The first light sensor (SNS) comprises several photodiodes and has the purpose of supplying the microprocessor (uP) and the EEPROM with supply voltages VuP and V_{MM}, respectively. The further light sensor (SNS_{F}) preferably has only one photodiode (for speed reasons) and has the purpose of delivering access information (IA) to the microprocessor (uP). The voltage conversion means (CNV) comprises, for example, a cascade of charge pumps. A conventional charge pump does not function properly if the input voltage (Uᵢ) is only periodically present during relatively short time periods. Therefore an inventive measure is applied to the voltage conversion means (CNV) which is briefly stated as follows: during the presence of the input voltage (Uᵢ), the charge pumps functions normally, but in the absence of the input voltage (Uᵢ) the switches in the charge pumps are kept in a holding state. The supply voltage (V_{MM}) is only delivered by the conversion means (CNV) when enough energy has been stored in the capacitors of the charge pumps. The clock signal of the microprocessor (uP) is held also when the input voltage (Uᵢ) is absent, and a switch (SBF) of the standby circuit (SB) is non-conducting. Therefore, the supply voltage V_{uP} remains present (because of the presence of a buffer capacitor (C_{BF})) in the absence of the input voltage (Uᵢ). The IC may be used, for example, as a copyright protection system in a CD player, where access information (AI) is processed by the microprocessor (uP) and stored in the memory means (MM). A so called “Key” may be stored in the memory means (MM). With this key, together with the access information (AI), an RF-signal can be sent back by the RF-oscillator to the CD-player. The CD-player can then decide whether, for example, a copy of the CD may be made.

The invention relates to an electronic circuit comprising conversion means for converting an input voltage into an output voltage, comprising at least a first energy storage means and a second energy storage means and switching means for periodically coupling said energy storage means to one another under the control of a clock signal so as to store energy in the energy storage means and transferring at least a portion of the stored energies between said means.

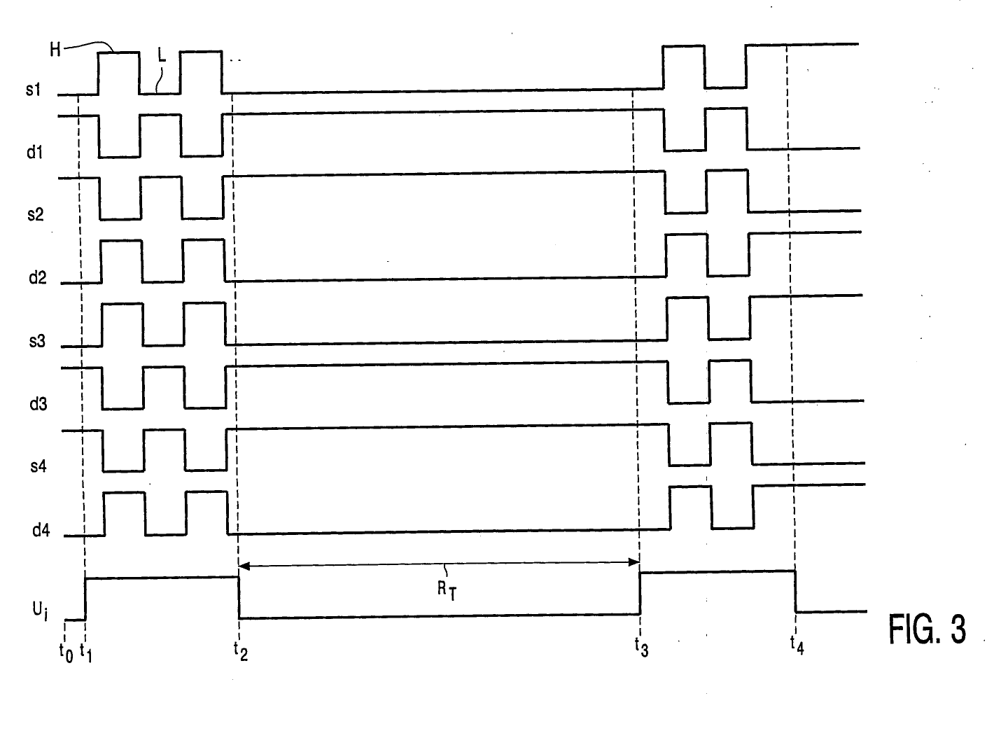

Such an electronic circuit is generally known in the art. An energy storage means may be constructed by means of a coil, in which case energy storage takes place by means of magnetic flux in the coil, and by means of a capacitor, in which case energy storage takes place by means of charge in the capacitor. The value of the output voltage may be higher as well as lower than the value of the input voltage. In the case of a voltage step-up, a favorite method is the use of a so-termed charge pump. Such a charge pump is known inter alia from U.S. Pat. No. 6,052,295. This patent discloses a voltage converter built up from a cascade of charge pumps. Each charge pump comprises a capacitor for storing energy, a switch, and a buffer. Both the switch and the buffer in each charge pump are controlled by clock signals originating from a clock generator. The clock signals are continuous periodic binary signals in time, the phases of the clock signals being suitably dimensioned with respect to one another. The manner of dimensioning is generally known to those skilled in the art of designing charge pumps and is also shown in FIG. 3 of the cited patent. The switches are usually constructed with transistors or with diodes.

It is a disadvantage of the known electronic circuit that it functions badly or not at all if the input voltage is present (periodically) during comparatively short time periods only.

It is accordingly an object of the invention to provide an electronic circuit with conversion means for converting an input voltage into an output voltage wherein the disadvantage mentioned above is eliminated or reduced.

According to the invention, the electronic circuit mentioned in the opening paragraph is for this purpose characterized in that the clock signal is kept in a holding state during a holding period during operation, which holding state is equal to the state of the clock signal immediately before the holding state.

The invention is based on the recognition that a voltage converter built up, for example, from a cascade of charge pumps can only function correctly if a comparatively constant input voltage is present, i.e. an input voltage that does not vary too much. If the input voltage is present during a comparatively short period only each time, the input voltage is in fact absent during the major portion of the time. Not only do the charge pumps stop building up energy in the capacitors then, but the stored energies in the capacitors even decrease. This is caused on the one hand by a power drop at the output of the converter (i.e. at the output of the final charge pump), and on the other hand by the fact that a portion of the built-up energies in the capacitors flows back to the input voltage source during the comparatively long time period in which this voltage source does not supply the input voltage. Furthermore, the stored energies also decrease owing to energy losses, especially in the switches which are switched on and off continuously and periodically. In the electronic circuit according to the invention, the above energy losses are largely prevented in that the states of the switches are frozen (open or closed), and in that the voltage levels at the inputs of the buffers are frozen during the time corresponding to the holding period mentioned above, in which the input voltage is absent.

The electronic circuit according to the invention may be highly advantageously used inter alia in an integrated circuit implemented in a medium for the storage and playback of information.

The invention accordingly also relates to a medium for storing and reading of information.

The invention further relates to a recording and playback device for storing and reading of information on and from said medium.

A first embodiment of a medium for storing and reading of information is characterized in that the medium comprises an integrated circuit which incorporates the electronic circuit according to the invention.

Such a medium may be used, for example, in a recording and playback device for recording and reading of user information such as, for example, music, in which the user information is encoded (“scrambled”) so as to counteract an illegal playing or illegal copying of, for example, an audio CD. Thus, for example, additional information may be coupled from a playback device to the integrated circuit. The integrated circuit may then return information to the device by means of which, in conjunction with a key stored in the integrated circuit, the coded information can be decoded (“descrambled”). The integrated circuit will be denoted IC hereinafter. Both the sending of information from the device to the IC and the return transmission of information from the IC to the device may take place by means of a radio frequency signal, which will be denoted RF signal hereinafter, or by means of an optical signal. Since an optical signal for the transmission of information requires comparatively much power, the information is preferably sent from the IC to the device by means of an RF signal.

A second embodiment of a medium is characterized in that the integrated circuit comprises a photosensitive sensor for providing the input voltage when the sensor receives a substantial quantity of light. Information may thus be optically transmitted to the IC. This is advantageous because photosensitive sensors can be integrated into the IC in a simple manner. In addition, the photosensitive sensor may be used in principle for providing the electronic circuit in the IC with a supply voltage, for example in that the photosensitive sensor is constructed with one or several photodiodes. The laser spot, which is always present in a CD player and which is normally only designed for reading and/or writing of the user information, may in principle also be used as a light source for transmitting the additional information to the IC. A separate light source, however, may also be used, for example one which is constructed with a light-emitting diode or LED. It is possible in principle to position the light source temporarily such that the light is exactly focused in a stationary manner onto the photosensitive sensor, i.e. the medium, being a disc in the case of a CD player, does not rotate during this time. A more or less constant input voltage is generated during this time, which voltage can remain sufficiently long for the capacitors in the charge pumps of the conversion means to be able to store sufficient energy in order to supply the required increased output voltage to the electronic circuit. Technically, however, it is found to be simpler to keep the disc rotating and not to stop it temporarily. Rotation is in fact a standard operation of a CD player which is necessary for writing and reading of user information. In this case the photosensitive sensor is periodically illuminated during a comparatively short time period only, and accordingly the input voltage is also present during comparatively short time periods, with the result that the capacitors in the charge pumps of the conversion means require a number of revolutions of the disc if they are to store a sufficient amount of energy for the supply of the required increased output voltage to the electronic circuit.

A third embodiment of a medium is characterized in that the IC furthermore comprises memory means which are provided with a supply voltage through utilization of the output voltage. Various types of non-volatile memories may be used such as, for example, an EEPROM (“Electrically Erasable Programmable Read Only Memory”). Reading and writing of the additional information from and to the EEPROM take place during time periods in which the conversion means have been able to build up a sufficient supply voltage for carrying out at least one writing or reading action. The writing or reading actions are temporarily stopped if there is an insufficient available quantity of stored energy in the conversion means for carrying out all required writing or reading actions immediately after one another, i.e. if the supply voltage for the EEPROM tends to fall below a minimum required value. The conversion means are then first given some time to build up a sufficient output voltage during a number of revolutions of the CD. The writing or reading actions are then resumed.

A fourth embodiment of a medium is characterized in that the IC in addition comprises a microprocessor and a further photosensitive sensor for providing additional information to the microprocessor, which microprocessor processes the additional information, and which microprocessor is coupled to the memory means for storing the processed additional information. The additional information may be, for example, access information which entitles a user to make a copy of the relevant CD at most three times. The microprocessor may in that case, for example, increment a stored number in the memory means. When information is sent back from the memory means to the recording/playback device, for example by means of an RF oscillator, this device can decide on the basis of this information whether or not a copy may be made.

In principle, the additional information may also be received without the addition of the further photosensitive sensor. The input voltage supplied by the photosensitive sensor mentioned first then has two functions: providing a voltage to the input of the voltage converter, and providing data to the microprocessor. It is desirable for an optimum fulfiliment of the former function that the photosensitive sensor is built up from several photodiodes connected in series. This is because a higher input voltage can be obtained in that manner. A side effect of this is that the parasitic capacitance of the photosensitive sensor is increased thereby. This is hardly of any importance for the provision of voltage to the input of the voltage converter. It is important, however, for the provision of data (additional information) to the microprocessor because the maximum speed with which the data can be processed is (potentially) reduced thereby. It is for this reason that the use of the further photosensitive sensor is advantageous. It may then be opted for to construct the further photosensitive sensor, for example, with only one photodiode, so that the parasitic capacitance remains low.

A fifth embodiment of a medium is an alternative to the fourth embodiment and is characterized in that the IC further comprises a microprocessor and a further photosensitive sensor for providing additional information to the memory means for the storage of the additional information, and in that the microprocessor is coupled to the memory means for processing the additional information after reading of the additional information from the memory means. The total amount of information is immediately stored in the memory means in this manner. It is only in a later stage, i.e. when the memory means are written out, that the microprocessor determines which information is redundant and which information, possibly processed by the microprocessor, is to be sent back to the recording and playback device.

An advantage of the fourth embodiment over the fifth embodiment is that fewer data are to be stored in the EEPROM.

The fifth embodiment has the potential advantage over the fourth embodiment that the transfer of data to the memory means can take place more quickly. Whether this advantage is actually achieved depends on the contents of the additional information. Indeed, the fact that a microprocessor is not used before the data are transferred to the memory means implies that potentially more data are to be stored. The speed of transfer of data to the memory means is reduced thereby.

A sixth embodiment of a medium is characterized in that the length of the holding period corresponds by approximation to that of a time period during which the photosensitive sensor does not receive a substantial quantity of light. This has the effect that the conversion means are brought into a state in which the stored energy is largely retained in the energy storage means during the periods in which the photosensitive sensor receives no or little light, and accordingly can supply no or hardly any input voltage to the input of the conversion means.

A seventh embodiment of a medium is characterized in that the microprocessor is idle during the holding period, and in that the microprocessor is provided with a supply voltage from a standby circuit during the holding period. The microprocessor is able to operate at a lower supply voltage than the EEPROM. As a result, the microprocessor may be supplied from the input voltage delivered by the photosensitive sensor. This saves energy. In fact, if the microprocessor were supplied from the output voltage delivered by the conversion means, there would be additional energy losses in the conversion means. It is even better, however, to couple the microprocessor not directly to the photosensitive sensor, but instead through the said standby circuit. The standby circuit in its simplest form consists of a switch and a buffer capacitor. When the input voltage is present, the switch is closed (conductive state), and the buffer capacitor is or becomes charged. The clock of the microprocessor is stopped during the holding period and accordingly becomes inactive. Should the supply voltage to the microprocessor be cut out, which would be the case without the presence of the standby circuit, certain operations not yet completed would have to be carried out later once more. This is prevented in that the microprocessor is supplied from the buffer capacitor during the holding state. The value of the buffer capacitor need not be very high. Since the microprocessor is inactive during the holding period, the current consumption of the microprocessor will be very low.

An eighth embodiment of a medium is characterized in that the medium is an optical discwhich has a side for storing and reading of the user information, while the IC is fastened to said side of the optical disc in a region not reserved for storing and reading of the user information. Said region is adjacent the center of the disc. The photosensitive sensors in the IC may in principle be illuminated by the same laser spot which is also used for writing and reading of the user information. The carriage in the device with which the laser spot can be moved into the desired location is not always capable of positioning the laser spot so closely adjacent the center of the disc, depending on the type of carriage. A separate light source may alternatively be used instead of this laser spot for illuminating the photosensitive sensors. This separate light source may be, for example, a second laser spot, or it may alternatively be implemented as an LED.

A ninth embodiment of a medium is characterized in that the medium is an optical disc which has a first side for storing and reading of the user information, while the IC is fastened to a second side of the optical disc. This has the advantage that the location of the IC is not limited to the immediate surroundings of the center of the disc.

The invention will be explained in more detail below with reference to the accompanying drawing, in which:

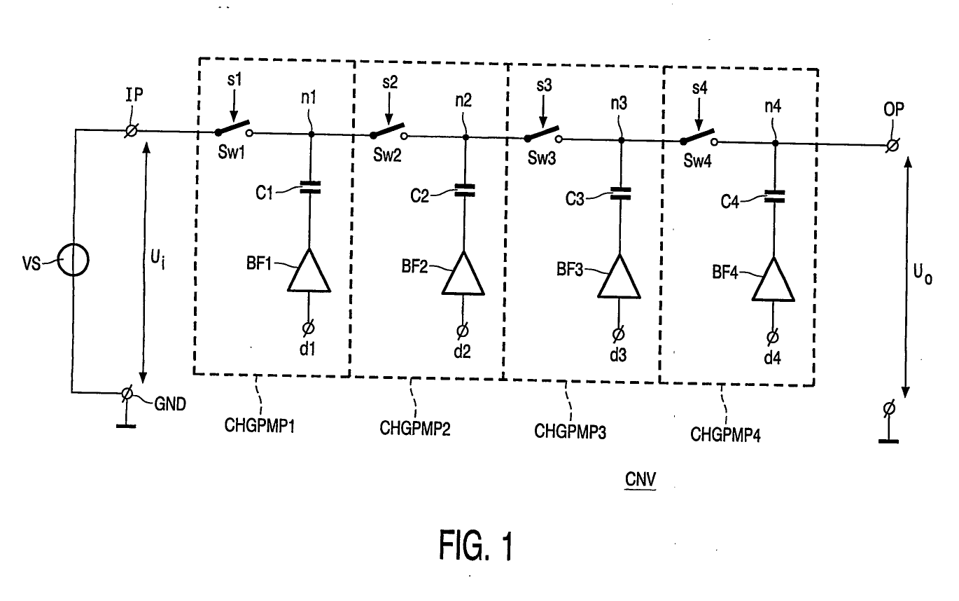

FIG. 1 is a circuit diagram of a known voltage converter built up from a cascade of charge pumps;

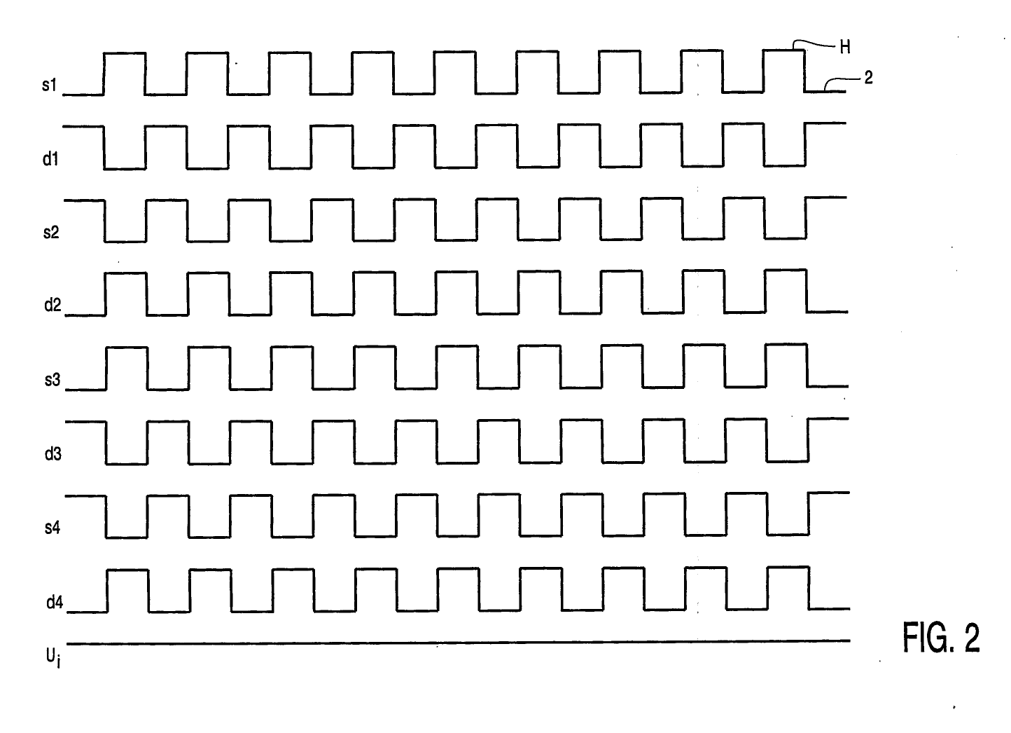

FIG. 2 shows a first set of signal diagrams for clarifying the operation of the known voltage converter;

FIG. 3 shows a second set of signal diagrams serving to clarify the operation of the voltage converter according to the invention;

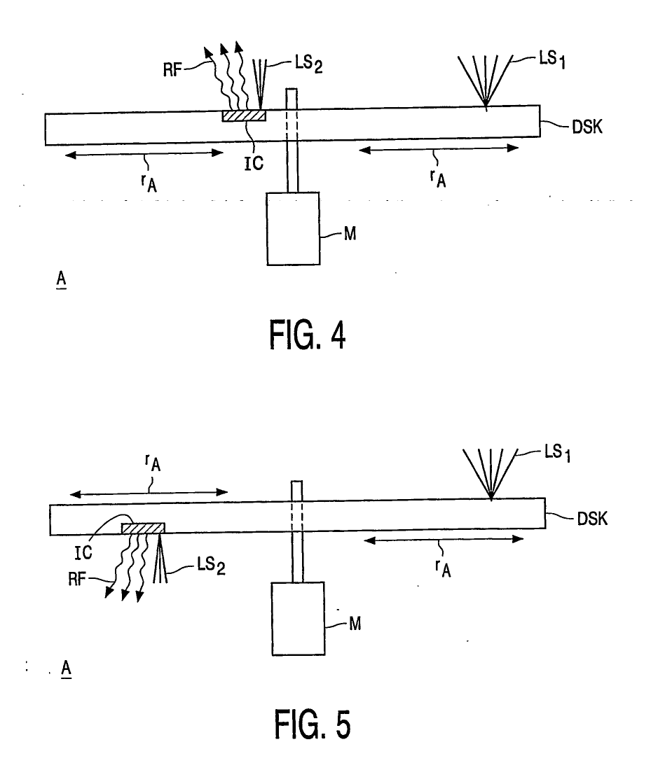

FIG. 4 shows a portion of a first embodiment of a recording/playback device according to the invention and a disc for the storage and reproduction of information;

FIG. 5 shows a portion of a second embodiment of a recording/playback device according to the invention and a disc for the storage and reproduction of information; and

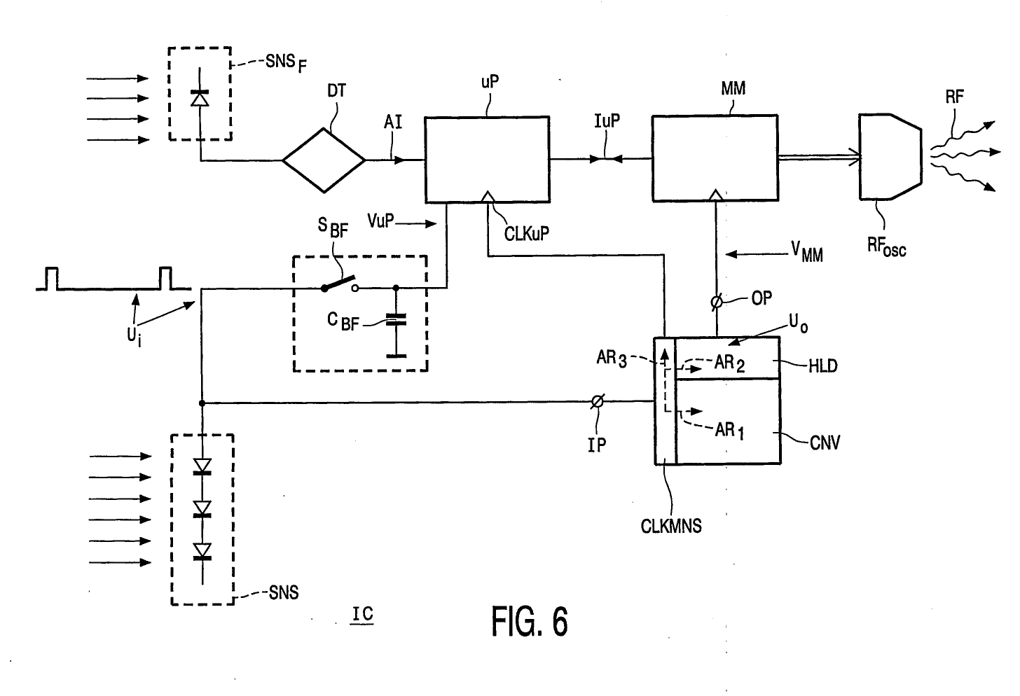

FIG. 6 shows an embodiment of an electronic circuit according to the invention in an IC implemented in a medium, such as a disc, according to the invention.

Identical components or elements have been given the same reference symbols in these Figures.

FIG. 1 is a circuit diagram of a known voltage converter CNV. The voltage converter CNV built up with a cascade of, in this example four, charge pumps CHGPMP1-CHGPMP4. The first charge pump CHGPMP1 comprises a first switch SW1 which is controlled with a first switch clock signal s1, a first charge pump capacitor C1, and a first buffer BF1 having an input which is controlled with a first buffer clock signal d1. An output of the first buffer BF1 is connected to a first terminal of the first charge pump capacitor C1. A second terminal of the first charge pump capacitor C1 is coupled via the first switch SW1 to an input IP of the voltage converter CNV. An input voltage Uᵢ is provided between the input IP and a ground reference terminal GND and is delivered by a voltage source VS. A common junction point n1 of the first charge pump capacitor C1 and the first switch SW1 forms an output of the first charge pump CHGPMP1. The second, third, and fourth charge pumps CHGPMP2-CHGPMP4 are built up in the same manner as the first charge pump CHGPMP1. The output of the fourth charge pump CHGPMP4 provides an output voltage U₀ between an output terminal OP of the voltage converter CNV and the ground terminal GND.

This voltage converter CNV is controlled in a known manner by the clock signals s1-s4 and d1-d4 as shown in FIG. 2. A high voltage value of the clock signals is written “H” and a low voltage value is written “L”. The voltage converter CNV operates correctly only if the input voltage Uᵢ is present (substantially) continuously, see also FIG. 2. In that case the voltage converter CNV is capable of supplying the output voltage U₀, which in this example is at most eight times higher than the input voltage Uᵢ. This is because each charge pump acts as a voltage doubler. The operation of a charge pump is generally known and may be briefly summarized as follows: in a first clock phase, d1 is logic low (“L”) and s1 is logic high (“H”), such that the switch SW1 is closed (conductive). As a result, the capacitor C1 is charged up to the value of the input voltage Uᵢ. In a second clock phase, s1 becomes logic low, which opens the switch SW1. Immediately afterwards (almost simultaneously), d1 becomes logic high, so that the potential at the first connection terminal of the capacitor C1 becomes equal to the value of the input voltage Uᵢ. (It is assumed here that the supply voltage of the buffer BF1 is equal to the value of Uᵢ.) Since the capacitor C1 temporarily retains its voltage with value Uᵢ, the potential at the junction point n1 becomes equal to twice the value of the input voltage Uᵢ at that moment.

As was noted above, said operation of the voltage converter CNV is only valid if the input voltage Uᵢ is present (substantially) continuously and not just periodically during the comparatively short periods as is the case with an input voltage Uᵢ as shown in FIG. 3. In FIG. 3, the input voltage Uᵢ is present during a comparatively short period only between moments t₁ and t₂. During a holding period RT between the moments t₂ and t₃, the input voltage Uᵢ is absent. Then the input voltage Uᵢ is present again between moments t₃ and t₄, and then is absent again during a holding period R_{T}, etc. The voltage converter according to the invention is now obtained through the use of the known voltage converter, but controlled by the modified clock signals according to the invention. The operation of the inventive voltage converter is as follows. The input voltage Uᵢ is present between the moments t₁ and t₂, and the clock signals (s1 to s4 and d1 to d4) correspond to the clock signals as shown in FIG. 2. Starting from moment t₂, however, the input voltage Uᵢ is absent. The states (“H”) or (“L”) of the clock signals are now frozen in the states the clock signals had immediately prior to the moment t₂ (see FIG. 3). The frozen states remain intact until the input voltage Uᵢ is present again at moment t₃. From that moment the clock signals continue in a manner corresponding to that as shown in FIG. 2. The states of the clock signals are frozen again starting from moment t₄ in the states the clock signals had immediately prior to the moment t₄, and so on. The effect of this is that the energies stored in the capacitors C1 to C4 remain largely intact during the holding periods R_{T}, in contrast to the known voltage converter.

FIG. 4 shows a portion of a first embodiment of a recording/playback device A according to the invention, with a disc DSK for storage and reproduction of information. The device A is, for example, a CD player. A disc DSK is driven herein by means of a motor M. User information, for example music, is read or written from or to the disc DSK in a known manner through the use of a laser which projects a light spot, i.e. a laser spot LS₁ onto an information layer of the disc DSK. The user information does not extend over the entire radius of the disc DSK, but is limited to a radial area r_{A}. The disc DSK is also provided with an IC. The IC can only be located in the region outside the radial area r_{A}. The IC is provided inter alia with photodiodes which are illuminated by a second light spot LS₂. In principle, the laser spot LS₁ may be used as the second light spot LS₂. It may be more practical (for example if the laser spot LS₁ cannot be positioned far enough towards the center of the disc DSK in a simple manner) to use a separate light source for the second light spot LS₂. If the IC is placed in a standard position, the separate light source may be given a fixed location, so that the cost is limited. The separate light source may be constructed, for example, with an LED, which is much cheaper than a laser. The IC comprises inter alia memory means MM (see FIG. 6) in which a “key” may be stored among other items. Additional information, such as access information, is sent to the IC by means of the LED. It can be determined in the IC on the basis of the additional information and the key whether, for example, the user is allowed to play or copy the CD. An RF signal is sent back from the IC to the CD player for this purpose.

FIG. 5 shows a portion of a second embodiment of a recording/playback device A according to the invention and a disc DSK for storage and reproduction of information. The difference with the first embodiment of FIG. 4 is that the IC is now accommodated at the other side of the disc DSK. Obviously, the LED will then illuminate the IC at this other side. The position of the LED may then also be chosen to lie within the radial area r_{A} as a result of this.

FIG. 6 shows an embodiment of an electronic circuit according to the invention in an IC implemented in a medium, such as a disc, according to the invention. The IC comprises a microprocessor uP, memory means MM, a voltage converter CNV, an RF oscillator (transmitter) RF_{osc}, detection means DT, a standby circuit SB, a photosensitive sensor SNS, and a further photosensitive sensor SNS_{F}.

The operation of the electronic circuit of FIG. 6 will now be clarified in conjunction with FIGS. 3 to 5. Light originating from, for example, the second light spot LS₂ is incident on the photosensitive sensors SNS and SNS_{F}. This takes place once in every revolution of the disc DSK. The photosensitive sensor SNS comprises a series arrangement of photodiodes and supplies the input signal Uᵢ, which has a voltage waveform as indicated in FIG. 6 and FIG. 3. The input voltage Uᵢ is delivered to the input terminal IP of the voltage converter CNV. The voltage converter CNV may be of the type shown in FIG. 1, but supplemented with clock means CLKMNS for providing the necessary clock signals as shown in FIG. 3. The clock means provide the necessary clock signals s1 to s4 and d1 to d4 (diagrammatically indicated by an arrow AR₁) to the voltage converter CNV, and a clock signal to a clock input CLKuP of the microprocessor uP (diagrammatically indicated with an arrow AR₂), and a clock signal to a holding circuit HLD that may be optionally added (indicated with an arrow AR₃). The standby circuit SB comprises a switch S_{BF} and a buffer capacitor C_{BF}. The moment light is incident on the sensor SNS, the switch S_{BF} is closed (conductive), and the microprocessor uP is provided with a supply voltage VuP. The buffer capacitor C_{BF} is or becomes charged. The comparatively low voltage supplied by the sensor SNS_{F} provides additional information, such as access information AI, to the microprocessor uP. It may be necessary first to adapt the signal waveform (inter alia the amplitude) first before it can be supplied to the microprocessor uP. Detection means DT may be added for this purpose, if necessary. The voltage U₀ at the output of the voltage converter CNV has become high enough after a number of revolutions of the disc DSK for serving as a supply voltage V_{MM} for the memory means MM which are constructed, for example, as an EEPROM. The holding means HLD, whose function it is to decouple the terminal OP from the output of the voltage converter CNV during the time in which the voltage U₀ is insufficient for supplying the required supply voltage V_{MM}, then couple the output of the voltage converter CNV to the output terminal OP. As long as the EEPROM is being provided with the supply voltage V_{MM}, the microprocessor uP can write information IuP to and from the EEPROM. During the holding period R_{T} (see FIG. 3), the switch S_{BF} is opened, the clock signal at the clock input CLKuP is stopped, the clock signals s1 to s4 and d1 to d4 are frozen (see FIG. 3), and the output terminal OP of the voltage converter CNV is decoupled again, so that the supply voltage V_{MM} disappears. The microprocessor uP may have been engaged on certain activities at the start of the holding period R_{T}, such as writing or reading of information IuP. The supply voltage VuP does not disappear during the holding period R_{T}. In fact, since the clock of the microprocessor uP has stopped, the microprocessor consumes substantially no current, with the result that it can be fed from the buffer capacitor C_{BF}. All states remain stored in the microprocessor uP as a result, and the microprocessor uP can resume its activities the moment the holding period R_{T} has elapsed. Information can be sent back from the memory means MM (or from the microprocessor uP) to the device A by means of the RF signal generated by the RF oscillator RF_{osc}.

1. An electroluminescent display comprising at least one display pixel (P), said display pixel (P) comprising at least:
a substrate (1);
a first electrode (2) deposited on or across said substrate (1);
an electroluminescent layer (4), and
a second electrode (5),
characterized in that said display pixel (P) further comprises at least one insulating structure (3′) within said display pixel (P) adapted to enhance the light output from said display pixel (P).

2. An electroluminescent display as claimed in claim 1, wherein said insulating structure (3′) is part of a dielectric insulating layer (3) deposited on or across the first electrode (2).

3. An electroluminescent display as claimed in claim 1, wherein said insulating structure is part of said substrate (1) as a top substrate layer (1″).

4. An electroluminescent display as claimed in claim 2, wherein said second electrode (5) comprises a reflective layer and said light output is enhanced by reflection at said reflective layer.

5. An electroluminescent display as claimed in claim 1, wherein said display pixel (P) comprises at least one side light output enhancing structure (3″).

6. An electroluminescent display as claimed in claim 5, wherein said side light output enhancing structure (3″) comprises walls (11,12) which are slanted to enhance the light output for light (9) generated in said electroluminescent layer of said display pixel (P) and to prevent output of light (9′) received from other display pixels of said electroluminescent display.

7. An electroluminescent display as claimed in claim 1, wherein said substrate (1) is adapted by at least one top substrate layer so as to allow total internal reflection for some light output of said display pixel (P).

8. An electroluminescent display as claimed in claim 7, wherein said substrate is thin compared to a lateral dimension of said display pixel (P).

9. An electroluminescent display as claimed in claim 7, wherein said substrate comprises top substrate layers adapted to allow said total internal reflection.

10. An electroluminescent display as claimed in claim 1, wherein, in operation, said insulating structure (3′) and/or said side light output enhancing structure (3″) provide areas of different brightness levels B within said display pixel P.

11. An electroluminescent display as claimed in claim 10, wherein said areas are patterned to provide images (15,16,17,18,19) with different brightness levels B.

12. An electronic device comprising an electroluminescent display as claimed in claim 1.

13. A method of manufacturing an electroluminescent display comprising at least one display pixel (P), the method at least comprising the steps of:
providing a substrate (1)
depositing a first electrode layer (2) on or across said substrate (1);
depositing an electroluminescent layer (4) on or across said first electrode layer (2);
depositing a second electrode layer (5) on or across said electroluminescent layer (4),
characterized in that said method further comprises a structuring step wherein at least one insulating structure (3′; 3″; 1″) is provided within said display pixel (P) adapted to enhance the light output from said display pixel (P).

14. A method as claimed in claim 13, wherein said structuring step is performed in an insulating layer (3) deposited in or across said first electrode (2).

15. A method as claimed in claim 13, wherein said structuring step is performed in said substrate (1).

16. A method as claimed in claim 13, wherein said substrate (1) comprises top substrate layers and said electroluminescent layer (4) comprises emissive layers, the method comprising the step of tuning the thickness of the top substrate layers and emissive layers so as to control the effects that enhance the light output.
